(19) United States
(12) Patent Application Publication
(10) Pub. No.: US 2007/0224982 A1
(43) Pub. Date: Sep. 27, 2007

(54) System and method for implementing multimedia services using remote device for mobile communication terminal

(75) Inventors: Ji-Youn Jeon, Seoul (KR); In-Oh Chung, Suwon-si (KR); Hyung-Wook Yoon, Seongnam-si (KR); Cheol-Yong Jeon, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/726,562

(22) Filed: Mar. 22, 2007

(30) Foreign Application Priority Data
Mar. 22, 2006 (KR) 2006-26145

(51) Int. Cl. H04Q 7/00; H04M 3/00

(52) U.S. Cl. 455/419; 370/331

(57) ABSTRACT

Provided is a system and method for implementing a multimedia service using a remote device for a mobile terminal. The method includes the mobile terminal transmitting data for the multimedia service to the remote device capable of providing high display and sound quality output and the remote device outputting high-quality multimedia data of the mobile terminal in terms of display and sound qualities, thereby effectively providing the multimedia service to users.

### PRIORITY

This application claims priority under 35 U.S.C. § 119 to an application entitled “System And Method For Implementing Multimedia Services Using Remote Device in Mobile Communication Terminal” filed in the Korean Intellectual Property Office on Mar. 22, 2006 and assigned Serial No. 2006-26145, the contents of which are incorporated herein by reference.

### BACKGROUND OF THE INVENTION

1. Field of the Invention

The present invention generally relates to a data transmission system and method, and in particular, to a system and method for transmitting data to a remote device from a mobile terminal.

2. Description of the Related Art

In an information communication field including electronic appliances (e.g., TVs, mobile terminals such as cellular phones and Personal Digital Assistants (PDAs), and computer systems) with the development of relevant technology, multimedia technology that combines and processes various forms of data such as still pictures, moving pictures, and voice data has been developed and various application services associated with such multimedia technology attract more popularity among consumers. In order to keep pace with this trend, the performance of relevant hardware is improved, a communication network is developed, and an information processing system and various services are developed, which makes various multimedia services possible.

Since the multimedia services mainly handle a large amount of image and sound data, the amount of data to be processed is huge. Thus, in order to process a huge amount of data, an exchange technique for providing a high-speed transmission line and various bandwidths as well as a technique for processing video and speech signals are required. In addition, a system for processing these techniques should be provided for improved multimedia services.

However, since most mobile devices for providing multimedia services to users, e.g., mobile terminals such as cellular phones and PDAs, have sizes minimized for users' convenience, there is a limit in a system for processing video and speech signals. Moreover, the screen of the mobile terminal is very small with the tendency of compactness, causing a limit in providing video information such as multimedia services and providing relevant information of voice and sound.

For example, a Digital Multimedia Broadcasting (DMB) terminal has a separate Liquid Crystal Display (LCD) for a DMB service in addition to a basic LCD for general functions, but it has a limit in providing High-Definition (HD) video services when compared to HDTVs or monitors of notebook computers. In addition, the size of the DMB terminal increases due to the separate LCD.

As described above, conventional mobile terminals providing multimedia services have small-size screens and low-performance sound systems, resulting in a failure to provide high-quality multimedia services in terms of display and sound qualities.

### SUMMARY OF THE INVENTION

It is, therefore, an object of the present invention to provide a system and a method for implementing multimedia services using a remote device for a mobile terminal, in which the mobile terminal transmits data for the multimedia services to the remote device capable of providing high display and sound quality output in order to provide the multimedia services through the remote device.

According to one aspect of the present invention, there is provided a system for implementing a multimedia service using a remote device for a mobile terminal. The system includes the mobile terminal for transmitting data for providing the multimedia service to the remote device if there is an input for providing the multimedia service from the remote device when multimedia data is being output and the remote device for outputting in real time multimedia data received from the mobile terminal.

According to another aspect of the present invention, there is provided a method for implementing a multimedia service using a remote device for a mobile terminal. In the method, the mobile terminal transmits data for providing the multimedia service to the remote device if there is an input for providing the multimedia service from the remote device when multimedia data is being output, and the remote device outputs in real time multimedia data received from the mobile terminal.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a structure of an Ad-Hoc network to which the present invention is applied;

FIG. 2 is a diagram illustrating the structure of an Ad-Hoc network using WiFi to which the present invention is applied;

FIG. 3 is block diagram illustrating the internal structures of a mobile terminal and a remote device in a communication network according to the present invention; and

FIG. 4 is a signal flowchart illustrating the transmission of multimedia data of a mobile terminal to a remote device and controlling the multimedia data according to the present invention.

### DETAILED DESCRIPTION OF THE PREFERRED EMBODIMENT

A preferred embodiment of the present invention will now be described in detail with reference to the accompanying drawings. In the following description, a detailed description of known functions and configurations incorporated herein has been omitted for conciseness.

The present invention provides a scheme to wirelessly transmit multimedia data from a mobile terminal to a remote device and to output the multimedia data from the remote device. Presently, wireless communication between the mobile terminal and the remote device can be performed via an Ad-Hoc network or an Ad-Hoc network using Wireless Fidelity (WiFi). Thus, in the present invention, the mobile terminal providing multimedia services and the remote device receiving multimedia data from the mobile terminal and providing the multimedia data constitute an Ad-Hoc network and communication therebetween is performed using WiFi.

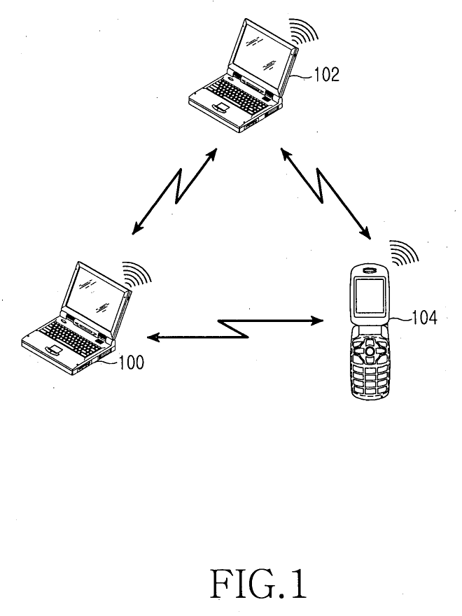

An Ad-Hoc network according to the present invention is a communication network only that includes a mobile host without a fixed cable network. The Ad-Hoc network has no constraint in the movement of the mobile host, it neither requires a cable network nor a base station and thus, it allows fast network construction, as well as can be constructed at low cost. Therefore, when it is not easy to construct a cable network or a constructed network is used only for a short period of time, or in an urgent situation or an environment that does not require continuous network connection, the Ad-Hoc network can be easily applied. Given these advantages, the concept of the Ad-Hoc network is applicable to various fields including multimedia services. In the Ad-Hoc network, every mobile node operates as a router and can have multiple paths to another node. Since the Ad-Hoc network can dynamically set the paths, it is called a network having no infra. In FIG. 1, nodes of an Ad-Hoc network can be a terminal 104, a notebook computer 100, and a PDA 102.

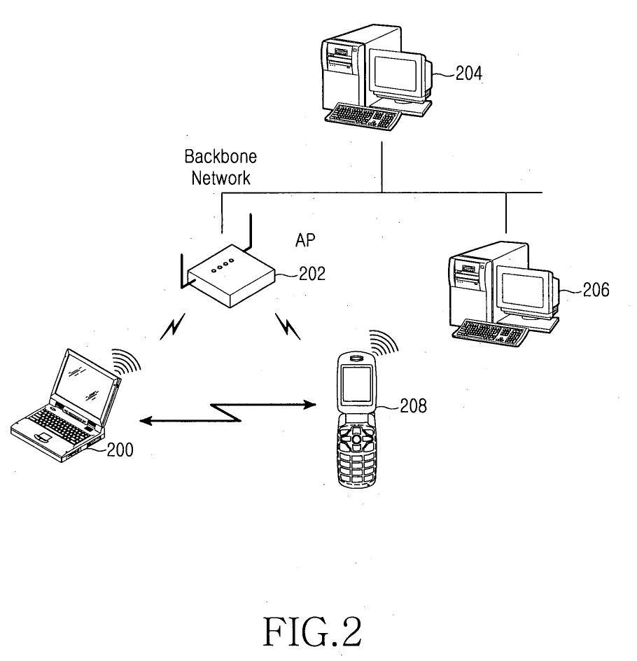

In an Ad-Hoc network using WiFi to which the present invention is applied, WiFi is a Local Area Network (LAN) using electronic wave or infrared transmission. Such a LAN is called WiFi meaning that it can allow a wireless network to be easily used like a HiFi audio system. WiFi can access a network through a PDA or a notebook computer within a predetermined distance range from an Access Point (AP) to provide a service such as Internet. A telephone line or a dedicated line is not required because a radio frequency is used, but a medium using a service, e.g., a PDA or a notebook computer, must have a wireless LAN card mounted therein. After wireless device companies such as Proxim Wireless Corporation and Symbol Technologies Corporate in America were initially commercialized in the late 1980s and WiFi certification was granted to a product compatible with Institute of Electrical and Electronics Engineers (IEEE) 802.11b that is determined to be a standard by Wireless Ethernet Capability Alliance (WECA, which was changed to WiFi in 2002) on September 1999, WiFi began to be developed. In Korea, WiFi was introduced in 2000 and has been actively researched by colleges and companies. At present, a large amount of multimedia information can be transmitted at a transfer rate of 11-54 Mbps and a fee for long-term use is low. In addition, WiFi is very useful for temporary establishment of a network in a department having complex cable connection, a hospital, a museum, an exhibition, a seminar, or a construction site. Although WiFi has problems to be solved such as security, frequency interference, power consumption, and roaming services, it is expected that its service range would expand and it would lead a 4^{th} Generation (4G) mobile communication field. In connection with a system configuration using WiFi, FIG. 2 is a diagram illustrating the structure of a system using a LAN technique in an Ad-Hoc network. Referring to FIG. 2, the system includes terminals 200 and 208 allowing WiFi, an AP 202, and a network. The terminals 200 and 208 can be PDAs, notebook computers, or terminals and must have a WiFi connection function by having a WiFi card mounted therein. The AP 202 serves as a hub or an Internet sharer according to network configuration and allows the terminals 200 and 208 to use a wireless Internet service. Transmission between the terminals 200 and 208 and the AP 202 can use infrared rays or frequencies. When frequencies are used for the transmission, broadband frequencies of 2.4 GHz can be used according to IEEE 802.11b and fast data communication at 54 Mbps is possible.

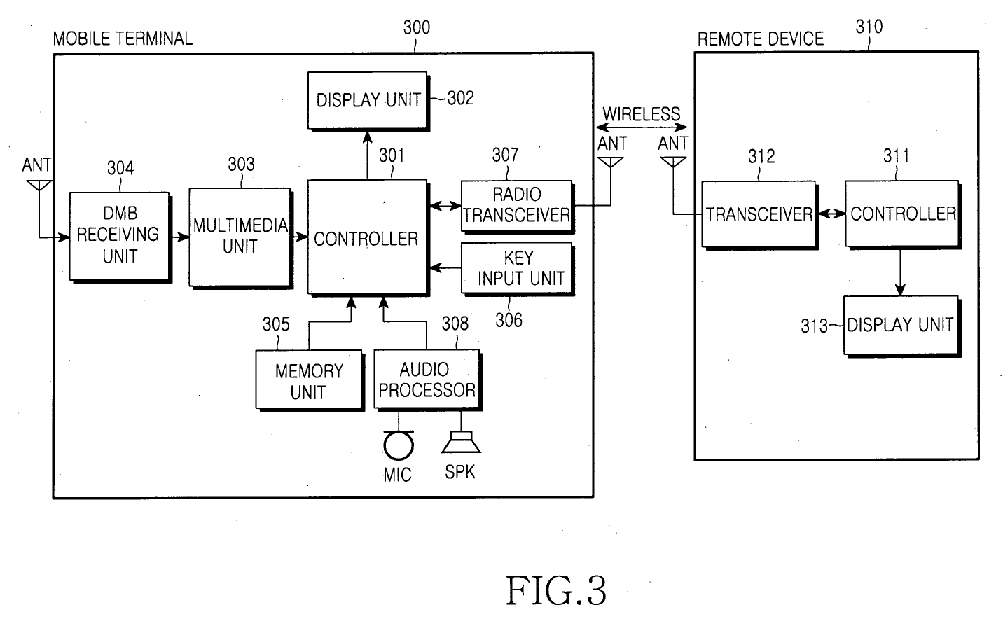

Hereinafter, the internal structures of a mobile terminal 300 and a remote device 310 in the network to which the present invention is applied will be described with reference to FIG. 3. In the present invention, the mobile terminal 300 transmits DMB data among multimedia data types to the remote device 310. However, the mobile terminal 300 can also transmit Moving Pictures Experts Group (MPEG) 4 moving pictures stored in the mobile terminal 300. In the following description, the mobile terminal 300 is a terminal capable of providing a DMB service.

The mobile terminal 300 includes a DMB receiving unit 340, a multimedia unit 303, a controller 301, a display unit 302, a memory unit 305, a radio transceiver 305, and a key input unit 306.

The controller 301 controls the overall operation of the DMB terminal 300. The controller 301 according to the present invention transmits multimedia data selected by a user to the remote device 310 in real time and, upon input of a command for controlling the output of multimedia data that is being output from the remote device 310, transmits the command to the remote device 310 for execution of the command.

The multimedia unit 303 serves as a controller when a DMB service is provided, and outputs video and audio data received through the DMB receiving unit 304 to the display unit 302 and an audio processor 308. The multimedia unit 303 includes a coder-decoder (codec).

The display unit 302 receives and displays display data according to key input data input from the key input unit 306 under the control of the controller 301 or visually shows a state where a user's desired function is set or driven.

The audio processor 308 is connected with a microphone MIC and a speaker SPK, converts an audio signal from the controller 301 and outputs the converted audio signal through the speaker SPK, and converts an audio signal from the microphone MIC into data and outputs the data to the controller 301.

The key input unit 306 is a device for an interface with a user and outputs unique key input data according to a key input. The key input data output from the key input unit 306 is provided to the controller 301 to detect a key input corresponding to the key input data and the controller 301 performs an operation corresponding to the detection result.

The memory unit 305 stores overall functions of the DMB terminal 300 and relevant information for providing a DMB service.

The radio transceiver 307 transmits data to and receives data from the remote device 310 through an antenna (ANT) under the control of the controller 301.

Hereinafter, the internal structure of the remote device 310 for receiving and outputting multimedia data output from the mobile terminal 300 will be described with reference to FIG. 3. In the present invention, the remote device 310 can be an HDTV or a notebook computer and can overcome limitations in a screen size and a voice and sound system for providing a multimedia service.

The remote device 310 includes a transceiver 312, a controller 311, and a display unit 313.

The transceiver 312 transmits multimedia data to and receives multimedia data from the mobile terminal 300 using a WiFi technique.

The controller 311 controls the overall operation of the remote device 310. In the present invention, the controller 311 controls the transceiver 312 to output multimedia data received from the mobile terminal 300. In addition, upon receipt of a command for controlling multimedia data that is being output from the mobile terminal 300, the controller 311 controls the output of the multimedia data according to the command.

The display unit 313 receives and displays display data under the control of the controller 311 or visually shows a state where a user's desired function is set or driven.

As mentioned above, when the mobile terminal 300 transmits multimedia data to the remote device 310 and the remote device 310 provides a multimedia service, the multimedia data can be output through the display unit 313 of the remote device 310 such as a notebook computer or an HDTV. Thus, it is possible to overcome limitations in a screen and a sound system, which are generated in a conventional mobile terminal and to allow users to enjoy a multimedia service having improved display and sound qualities.

In a communication system as structured above, the mobile terminal 300 has multimedia data for a multimedia data transmission service and the remote device 310 receives multimedia data from the mobile terminal 300 and provides the received multimedia data to the user. To this end, the mobile terminal 300 and the remote device 310 form an Ad-Hoc network and transmit/receive data using the WiFi technique. In the Ad-Hoc network of the present invention, an AP is not required and the mobile terminal 300 and the remote device 310 have a WiFi function.

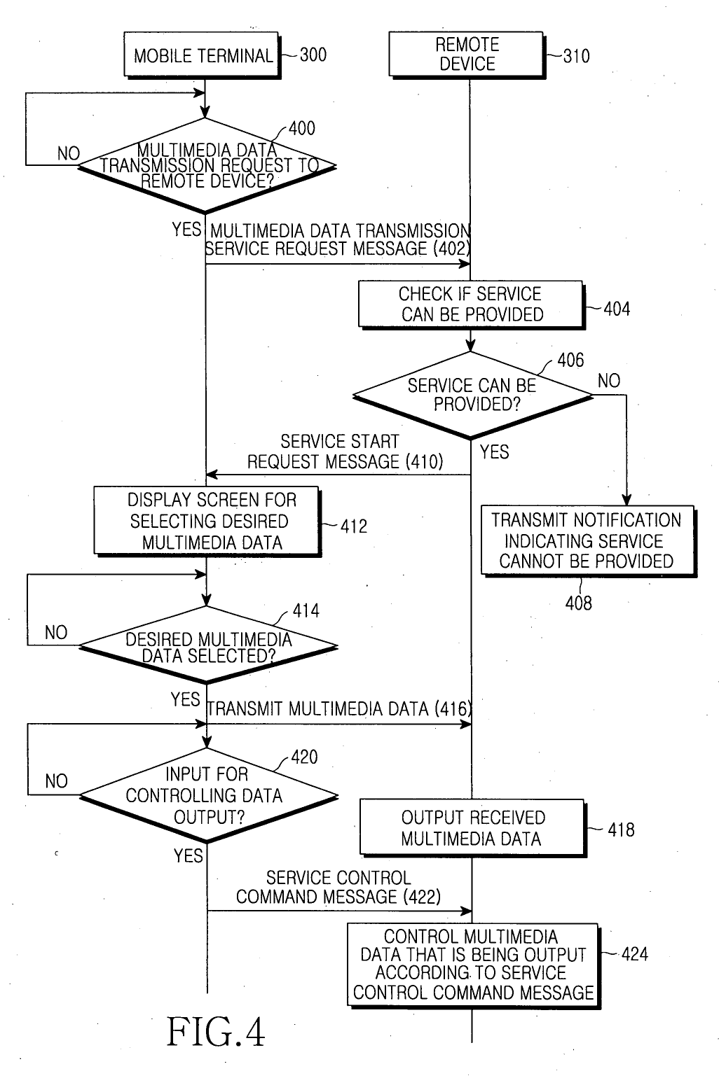

Hereinafter, a signal flow between the mobile terminal 300 and the remote device 310 to transmit multimedia data from the mobile terminal 300 to the remote device 310 in real time using WiFi in the communication system of FIG. 3 will be described with reference to FIG. 4. FIG. 4 is a signal flowchart between the mobile terminal 300 and the remote device 310 to transmit multimedia data of the mobile terminal 300 to the remote device 310 and control the multimedia data according to an embodiment of the present invention.

Referring to FIG. 4, when the mobile terminal 300 outputs DMB or an MPEG 4 moving picture stored in a memory, the mobile terminal 300 checks if a request for transmitting multimedia data to the remote device 310 is input by the user through the key input unit 306 in step 400. If the request is input by the user, the mobile terminal 300 transmits a multimedia data transmission service request message to the remote device 310 in step 402. At this time, a message transmitted and received between the mobile terminal 300 and the remote device 310 is assumed to be agreed upon between the mobile terminal 300 and the remote device 310. In addition, a multimedia data transmission service means a service by which the mobile terminal 300 transmits multimedia data to the remote device 310 in real time and the remote device 310 receives the multimedia data and provides the received multimedia data to the user. To provide the multimedia data transmission service, the mobile terminal 300 must know the IP address of the remote device 310 and access the remote device 310 through the IP address for transmission of multimedia data.

Upon receipt of a request for the multimedia data transmission service from the mobile terminal 300, the remote device 310 checks if it can provide the multimedia data transmission service in step 404. At this time, this involves checking if the remote device 310 can output presently received multimedia data. If the remote device 310 can output the multimedia data in step 406, it proceeds to step 410 to transmit a service start request message to the mobile terminal 300. Otherwise, the remote device 310 proceeds to step 408 to transmit a notification indicating that it cannot provide the multimedia data transmission service to the mobile terminal 300.

The mobile terminal 300 receiving the service start request message displays a screen for selecting multimedia data to be transmitted in step 412. In step 414, if the user selects desired multimedia data, then in step 416, the mobile terminal 300 transmits the selected multimedia data to the remote device 310.

The remote device 310 receiving the multimedia data outputs the received multimedia data in step 418. Simply, the remote device 310 displays the received multimedia data through the display unit 313.

In the present invention, the request for the multimedia data transmission service and the service start request message are transmitted and received between the mobile terminal 300 and the remote device 310 and the mobile terminal 300 transmits its data to the remote device 310 to provide a corresponding multimedia data service. Once the mobile terminal 300 completes data transmission to the remote device 310 for the multimedia service, the remote device 310 executes received data, thereby providing the multimedia service to the user in a better environment than in the mobile terminal 300.

When the remote device 310 outputs the multimedia data received from the mobile terminal 310 in steps 400 through 418, the mobile terminal 300 checks if there is an input for controlling data output from the user in step 420. If there is the input from the user, a service control command message is transmitted to the remote device 310 in step 422.

Upon receiving the service control command message, the remote device 310 controls multimedia data that is being output, according to the service control command message. At this time, the service control command message may be pause, stop, mute, volume up/down, fast forward/reverse, or full screen.

Simply, the mobile terminal 300 can transmit a command for controlling a multimedia service selected by the user to the remote device 310 to control the multimedia service provided by the remote device 310. The remote device 310 receiving the service control command message from the mobile terminal 300 executes an operation corresponding to the service control command message.

As described above, according to the present invention, the mobile terminal 300 transmits data for the multimedia service to the remote device 310 capable of providing high display and sound quality output and the remote device 310 outputs high-quality multimedia data of the mobile terminal 300 in terms of display and sound qualities, thereby effectively providing the multimedia service to users.

While the present invention has been shown and described with reference to a preferred embodiment thereof, it will be understood by those skilled in the art that various changes in form and details may be made therein without departing from the spirit and scope of the invention as defined by the appended claims.

What is claimed is:

1. A system for implementing a multimedia service using a remote device for a mobile terminal, the system comprising:
the mobile terminal for transmitting data for providing the multimedia service to the remote device if there is an input for providing the multimedia service from the remote device when multimedia data is being output; and
the remote device for outputting in real time multimedia data received from the mobile terminal.

2. The system of claim 1, wherein the mobile terminal transmits a multimedia data transmission service request message to the remote device if there is an input for providing the multimedia service through the remote device.

3. The system of claim 2, wherein the remote device checks if the multimedia service can be provided upon receipt of the multimedia data transmission service request message, and transmits a service start request message to the mobile terminal if the multimedia service can be provided.

4. The system of claim 3, wherein the mobile terminal displays a screen for selecting a multimedia service to be transmitted to the remote device upon receipt of the service start request message and transmits in real time multimedia data corresponding to the multimedia service selected by the user to the remote device.

5. The system of claim 4, wherein if there is an input from the user for controlling the output of multimedia data that is being transmitted to the remote device, the mobile terminal transmits a service control command message including the input from the user to the remote device.

6. The system of claim 5, wherein if the remote device receives the service control command message from the mobile terminal while receiving the multimedia data from the mobile terminal and outputting the received multimedia data, it controls the multimedia data that is being output according to the service control command message.

7. The system of claim 1, wherein the remote device is capable of outputting the multimedia data as high display and sound quality data.

8. The system of claim 1, wherein the mobile terminal and the remote device include Wireless Fidelity (WiFi) devices for wireless communication through WiFi and transmit and receive data therebetween through their WiFi devices.

9. A method for implementing a multimedia service using a remote device for a mobile terminal, the method comprising:
the mobile terminal transmitting data for providing the multimedia service to the remote device if there is an input for providing the multimedia service from the remote device when multimedia data is being output; and
the remote device outputting in real time multimedia data received from the mobile terminal.

10. The method of claim 9, further comprising transmitting, by the mobile terminal, a multimedia data transmission service request message to the remote device if there is the input for providing the multimedia service through the remote device.

11. The method of claim 10, further comprising checking, by the remote device if the multimedia service can be provided upon receipt of the multimedia data transmission service request message, and transmitting a service start request message to the mobile terminal if the multimedia service can be provided.

12. The method of claim 11, further comprising displaying, by the mobile terminal a screen for selecting a multimedia service to be transmitted to the remote device upon receipt of the service start request message and transmitting in real time multimedia data corresponding to the multimedia service selected by the user to the remote device.

13. The method of claim 11, further comprising, if there is an input from the user for controlling the output of multimedia data that is being transmitted to the remote device, the mobile terminal transmitting a service control command message including the input from the user to the remote device.

14. The method of claim 13, further comprising the step of, if the remote device receives the service control command message from the mobile terminal while receiving the multimedia data from the mobile terminal and outputting the received multimedia data, the remote device controlling the multimedia data that is being output according to the service control command message.
